(19) United States
(12) Patent Application Publication
(10) Pub. No.: US 2009/0162138 A1
(43) Pub. Date: Jun. 25, 2009

(54) LONGITUDINAL MEMBER ASSEMBLY WITH JOINT

(75) Inventors: FRANK BURGER, ORTONVILLE, MI (US); LEN V. PESCHANSKY, WEST BLOOMFIELD, MI (US); PAOLO V. SARTI, WASHINGTON, MI (US); DAVID L. VON KNORRING, OXFORD, MI (US); STEVEN K. MACKENZIE, WEST BLOOMFIELD, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/959,542

(22) Filed: Dec. 19, 2007

(51) Int. Cl. F16B 7/00; F16B 11/00; F01N 7/18

(52) U.S. Cl. 403/271; 403/383; 228/176

(57) ABSTRACT

A longitudinal member assembly having a primary loading direction, including an interior longitudinal member and an exterior longitudinal member, and a method of assembly, is disclosed. The interior longitudinal member has a boxed-section shape including a first side and an opposed second side parallel to the first side. The exterior longitudinal member has a boxed shape including a first exterior side and an opposed second exterior side parallel to the first exterior side. The interior member is telescopically received in the exterior member creating an overlap area, the first exterior side includes a first side welding hole, and the second exterior side includes a second side welding hole. A first side hole weld extends around the first side welding hole, and a second side hole weld extends around the second side welding hole. The first and second holes are parallel to the primary loading direction.

### BACKGROUND OF INVENTION

The present invention relates generally to an assembly of longitudinal members, and more particularly to a joint for attaching two boxed-section shaped longitudinal members.

Various shaped longitudinal members are employed as frame components in vehicle frames. Such sections may be I-beam sections, C-sections, circular sections, or boxed-section members. For some applications, the boxed-section members may be advantageous. The boxed-section members have a generally rectangular cross section. It is desirable to provide a robust method for joining longitudinal members with these boxed-section shapes. Some have employed simple circumferential welding of the two boxed-section members together, while others have employed riveted joints. However, neither is entirely satisfactory in efficiently producing a robust joint that secures two boxed-section members together.

### SUMMARY OF INVENTION

An embodiment contemplates a longitudinal member assembly having a primary loading direction, with the assembly including an interior longitudinal member and an exterior longitudinal member. The interior longitudinal member has a boxed-section shape including a first side and an opposed second side parallel to and spaced from the first side, with the first and second sides being parallel to a plane defined by a longitudinal axis oriented along a length of the interior longitudinal member and a primary loading direction axis that extends parallel to the primary loading direction and perpendicular to the longitudinal axis. The interior longitudinal member also includes a lower side extending between the first and second sides, and an upper side extending between the first and second sides and spaced from the lower side. The exterior longitudinal member has a boxed shape including a first exterior side and an opposed second exterior side parallel to and spaced from the first exterior side, the first and second exterior sides being parallel to the first and second sides, with the exterior longitudinal member including a lower exterior side extending between the first and second exterior sides, and an upper exterior side extending between the first and second exterior sides and spaced from the lower exterior side. The interior longitudinal member is telescopically received in the exterior longitudinal member to define an overlap area, and the first exterior side includes a first side welding hole located in the overlap area. A first side hole weld extends around at least a portion of a perimeter of the first side welding hole and engages the first side to thereby secure the exterior longitudinal member to the interior longitudinal member. The second exterior side may include a second side welding hole located in the overlap area, and a second side hole weld extending around at least a portion of a perimeter of the second side welding hole.

An embodiment contemplates a longitudinal member assembly having a primary loading direction, with the assembly including an interior longitudinal member and an exterior longitudinal member. The interior longitudinal member has a boxed-section shape including a first side, an opposed second side parallel to and spaced from the first side, a lower side extending between the first and second sides, and an upper side extending between the first and second sides and spaced from the lower side. The exterior longitudinal member has a boxed shape including a first exterior side, an opposed second exterior side parallel to and spaced from the first exterior side, a lower exterior side extending between the first and second exterior sides, and an upper exterior side extending between the first and second exterior sides and spaced from the lower exterior side, with the first and second exterior sides being parallel to the first and second sides. The interior longitudinal member is telescopically received in the exterior longitudinal member to define an overlap area, the first exterior side includes a first side welding hole located in the overlap area, and the second exterior side includes a second side welding hole located in the overlap area. A first side hole weld extends around at least a portion of a perimeter of the first side welding hole and engages the first side, and a second side hole weld extends around at least a portion of a perimeter of the second side welding hole and engages the second side.

An embodiment contemplates a method of forming a longitudinal member joint between a boxed-section interior longitudinal member and a boxed-section exterior longitudinal member, the method comprising the steps of: forming a first side welding hole in a first side of the exterior longitudinal member, with the first side being parallel to a plane defined by a longitudinal axis oriented along a length of the interior longitudinal member and a primary loading direction axis that extends parallel to a primary loading direction and perpendicular the longitudinal axis; forming a second side welding hole in a second side of the exterior longitudinal member, with the second side being parallel to and spaced from the first side; telescopically inserting the interior longitudinal member into the exterior longitudinal member creating an overlap area where a first internal side of the interior longitudinal member is adjacent to the first side welding hole and a second internal side of the interior longitudinal member is adjacent to the second side welding hole; welding at least a portion of a perimeter of the first side welding hole to the first internal side; and welding at least a portion of a perimeter of the second side welding hole to the second internal side.

An advantage of an embodiment is that, by transferring tension-compression loads in longitudinal members into shear loads in the side walls parallel to the principal bending direction, the shear load transfer occurs in stable parent material of the boxed-section shaped members, where there are few stress concentrations and crack initiators. Thus, a relatively simple, robust method for joining longitudinal boxed-section members is achieved.

### BRIEF DESCRIPTION OF DRAWINGS

FIG. 1 is a perspective view of a longitudinal member assembly.

FIG. 2 is a view similar to FIG. 1, but shown from a different direction.

FIG. 3 is a view similar to FIG. 1, but illustrating a second embodiment.

FIG. 4 is a view similar to FIG. 1, but illustrating a third embodiment.

### DETAILED DESCRIPTION

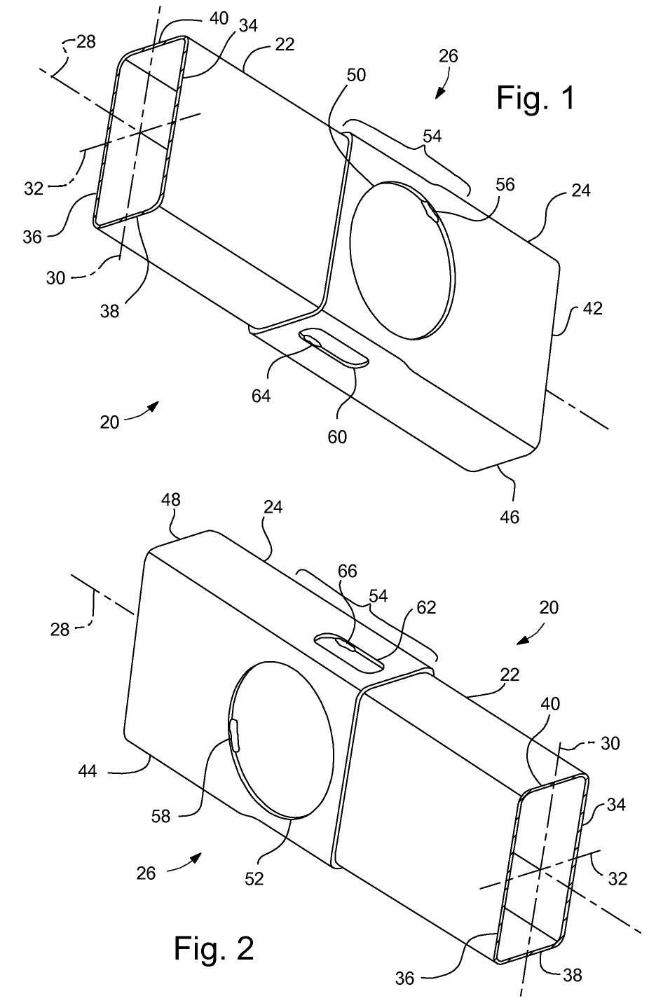

Referring to FIGS. 1-2, a longitudinal member assembly, indicated generally at 20, is shown. The longitudinal member assembly 20 may be employed, for example, in a frame of a vehicle (not shown). The longitudinal member assembly includes an interior longitudinal member 22 and an exterior longitudinal member 24 that are connected together at a longitudinal member joint 26. Both the interior and exterior longitudinal members 22, 24 are boxed-section members—that is, their cross-sectional areas are generally rectangular shapes.

Features of the longitudinal member assembly 20 may be defined by axes that extend relative to the assembly 20. A longitudinal axis 28 extends along the length of the members 22, 24. A first, lateral, primary loading direction axis 30 extends generally normal to the longitudinal axis 28 and is oriented parallel to a primary bending direction. The primary bending direction is a direction that a primary bending load will be induced in the longitudinal member assembly 20 when in use. A second lateral axis 32 is oriented generally normal to the first two axes 28, 30.

The interior longitudinal member 22 has a shape that is complimentary to and smaller than the exterior longitudinal member 24, which allows it to telescopically slide into the exterior longitudinal member 24. The interior longitudinal member 22 has a first side 34 and a second side 36 that both extend parallel to a plane defined by the first lateral axis 30 and the longitudinal axis 28, and a lower side 38 and an upper side 40 that both extend parallel to a plane defined by the second lateral axis 32 and the longitudinal axis 28. The terms upper/top and lower/bottom as used herein are just for reference to the drawings, as the members 22, 24 and primary bending direction can be oriented in various directions in space, depending upon the particular application for the longitudinal member assembly 20. The first and second sides 34, 36 may be wider than the lower and upper sides 38, 40 since these sides extend parallel to the direction of the primary bending loads.

When referring to “parallel” herein, it includes elements that are close to being parallel, even if not exactly parallel. For example, the generally rectangular shapes of the interior and exterior longitudinal members 22, 24 may be slightly trapezoidal in shape, with the side walls 34, 36, 42, 44 tipped at an angle of up to about ten degrees from the plane defined by the first lateral axis 30 and the longitudinal axis 28. Accordingly, the term “parallel” as used herein also includes up to about ten degrees of angle from exactly parallel.

The exterior longitudinal member 24 has a first side 42 and a second side 44 that both extend parallel to a plane defined by the first lateral axis 30 and the longitudinal axis 28. The exterior longitudinal member 24 also has a lower side 46 and an upper side 48 that both extend parallel to a plane defined by the second lateral axis 32 and the longitudinal axis 28. The first side 42 includes a first side welding hole 50, and the second side 44 includes a second side welding hole 52. Thus, these holes 50, 52 are in the sides that extend parallel to the primary bending direction. The holes 50, 52 may be circular, oval, elliptical, or other geometrically smooth shape. Square or other shapes with corners may be used but are not as desirable due to the stress concentrations that may form in the corners of the shapes. The holes 50, 52 extend within an overlap area 54, where the interior longitudinal member 22 overlaps with the exterior longitudinal member 24. Also, the holes 50, 52 are preferably the same size and shape, but do not have to be.

A first side hole weld 56 extends around the periphery of the first side welding hole 50 (only a portion of the weld shown), and a second side hole weld 58 extends around the periphery of the second side welding hole 52 (only a portion of the weld shown). These welds 56, 58 secure the exterior longitudinal member 24 to the interior longitudinal member 22.

The lower side 46 of the exterior longitudinal member 24 may include a hole, such as a lower slot 60, and the upper side 48 may include a hole, such as an upper slot 62. A lower slot weld 64 extends around the periphery of the lower slot 62 (only a portion of the weld shown), and an upper slot weld 66 extends around the periphery of the upper slot 62 (only a portion of the weld shown). These welds 64, 66 also secure the exterior longitudinal member 24 to the interior longitudinal member 22. The welds employed may be, for example, fillet welds or plug welds.

The longitudinal member assembly 20 may be assembled by telescopically sliding the interior longitudinal member 22 into the exterior longitudinal member 24 until the two longitudinal members 22, 24 overlap by a desired amount (defining the overlap area 54). A welding operation forms the first and second side hole welds 56, 58 around the perimeters of the first and second side welding holes 50, 52, respectively. The welding operation also forms the lower and upper slot welds 64, 66 around the perimeters of the lower and upper slots 60, 62, respectively. The two longitudinal members 22, 24 are now secured together at the longitudinal member joint 26.

With this longitudinal member joint 26, as a primary load is directed downward onto the longitudinal member assembly 20, the joint 26 transfers tension/compression loads in the members 22, 24 into shear loads transferring between the first sides 34, 42 and shear loads transferring between the second sides 36, 44. The shear load transfer is advantageous in that the load transfer is occurring in the stable parent metal of the longitudinal members 22, 24, where there are few stress concentrations and crack initiators. The welds 64, 66 at the lower and upper slots 60, 62 may also assist in transferring load between the members 22, 24. Any torsion loads may be carried by surface contact in the overlap area 54 of the two members 22, 24.

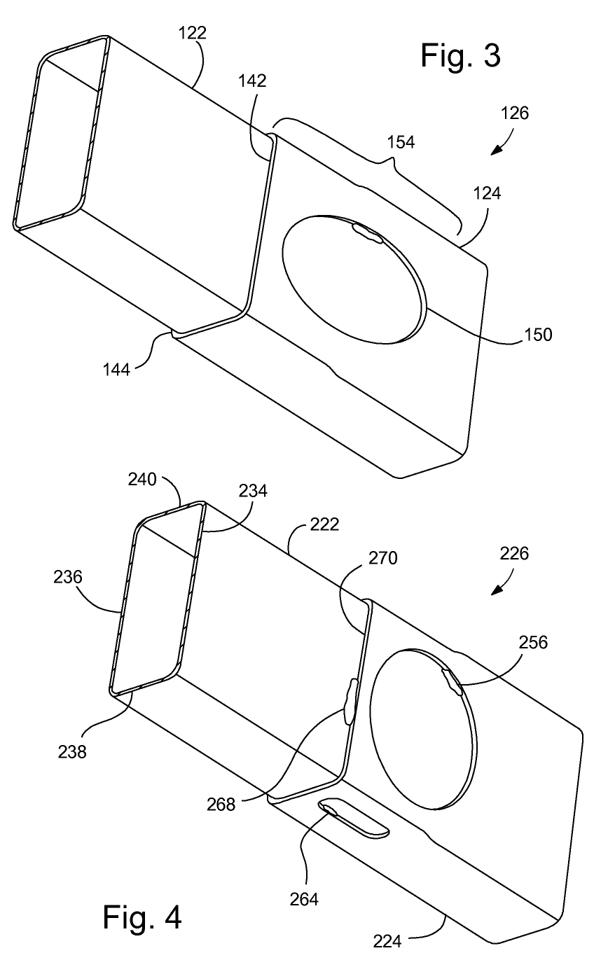

FIG. 3 illustrates a second embodiment. Since this embodiment is similar to the first, similar element numbers will be used for similar elements, but employing 100-series numbers. In this embodiment, the first side welding hole 150 in the first side 142 of the exterior longitudinal member 124 and the second side welding hole (not shown in this embodiment) in the second side 144 of the exterior longitudinal member 124 are an oval rather than circular shape. But both welding holes are still within the overlap area 154 of the longitudinal member joint 126. Also, the upper slot and lower slot have been eliminated. The assembly of the interior longitudinal member 122 to the exterior longitudinal member 124 may be the same as the first embodiment—of course, with the elimination of the weld operations for upper and lower slots.

FIG. 4 illustrates a third embodiment. Since this embodiment is similar to the first, similar element numbers will be used for similar elements, but employing 200-series numbers. In this embodiment, both the first side hole weld 256 and the second side hole weld (not shown in this embodiment)—as well as the lower slot weld 264 and the upper slot weld (not shown in this embodiment)—are employed to form the longitudinal member joint 226 securing the interior longitudinal member 222 to the exterior longitudinal member 224. In addition, a perimeter weld 268 (only a portion of the weld shown) extends around a portion or all of a perimeter of an end 270 of the exterior longitudinal member 224, securing this end 270 to some or all of the sides 234, 236, 238, 240 of the interior longitudinal member 222. This perimeter weld 268, then, may carry the torsion load between the two members 222, 224.

Although certain features have been shown only in certain embodiments, these features may be used in the other embodiments as well. For example, the side welding holes may be oval in the first and third embodiments, and the first and second embodiments may include perimeter welds. Also, changes in the length of the overlap area, thickness of the longitudinal members, addition or deletion of slots and slot welds, and other characteristics may be varied to tune the joint for optimal performance based on anticipated loading conditions.

While certain embodiments of the present invention have been described in detail, those familiar with the art to which this invention relates will recognize various alternative designs and embodiments for practicing the invention as defined by the following claims.

What is claimed is:

1. A longitudinal member assembly having a primary loading direction comprising:
an interior longitudinal member having a boxed-section shape including a first side and an opposed second side parallel to and spaced from the first side, the first and second sides being parallel to a plane defined by a longitudinal axis oriented along a length of the interior longitudinal member and a primary loading direction axis that extends parallel to the primary loading direction and perpendicular to the longitudinal axis, the interior longitudinal member also including a lower side extending between the first and second sides, and an upper side extending between the first and second sides and spaced from the lower side;
an exterior longitudinal member having a boxed shape including a first exterior side and an opposed second exterior side parallel to and spaced from the first exterior side, the first and second exterior sides being parallel to the first and second sides, and the exterior longitudinal member including a lower exterior side extending between the first and second exterior sides, and an upper exterior side extending between the first and second exterior sides and spaced from the lower exterior side, wherein the interior longitudinal member is telescopically received in the exterior longitudinal member to define an overlap area, and wherein the first exterior side includes a first side welding hole located in the overlap area; and
a first side hole weld extending around at least a portion of a perimeter of the first side welding hole and engaging the first side to thereby secure the exterior longitudinal member to the interior longitudinal member.

2. The assembly of claim 1 wherein the second exterior side includes a second side welding hole located in the overlap area, and a second side hole weld extends around at least a portion of a perimeter of the second side welding hole and engages the second side.

3. The assembly of claim 2 wherein the upper exterior side includes an upper welding hole, and an upper weld extends around at least a portion of a perimeter of the upper welding hole and engages the upper side.

4. The assembly of claim 1 wherein the upper exterior side includes an upper welding hole, and an upper weld extends around at least a portion of a perimeter of the upper welding hole and engages the upper side.

5. The assembly of claim 4 wherein the lower exterior side includes a lower welding hole, and a lower weld extends around at least a portion of a perimeter of the lower welding hole and engages the lower side.

6. The assembly of claim 5 wherein the exterior longitudinal member includes an end, and a perimeter weld extends around at least a portion of the end and engages the interior longitudinal member.

7. The assembly of claim 1 wherein the exterior longitudinal member includes an end, and a perimeter weld extends around at least a portion of the end and engages the interior longitudinal member.

8. The assembly of claim 1 wherein the first side welding hole has a circular shape.

9. The assembly of claim 1 wherein the first side welding hole has an oval shape.

10. The assembly of claim 1 wherein a lateral axis is defined perpendicular to the longitudinal and the primary loading direction axes, and the upper side and the upper exterior side are parallel to a plane defined by the lateral axis and the longitudinal axis, and wherein the upper exterior side includes an upper welding hole, and an upper weld extends around at least a portion of a perimeter of the upper welding hole and engages the upper side.

11. A longitudinal member assembly having a primary loading direction comprising:
an interior longitudinal member having a boxed-section shape including a first side, an opposed second side parallel to and spaced from the first side, a lower side extending between the first and second sides, and an upper side extending between the first and second sides and spaced from the lower side;
an exterior longitudinal member having a boxed shape including a first exterior side, an opposed second exterior side parallel to and spaced from the first exterior side, a lower exterior side extending between the first and second exterior sides, and an upper exterior side extending between the first and second exterior sides and spaced from the lower exterior side, the first and second exterior sides being parallel to the first and second sides, wherein the interior longitudinal member is telescopically received in the exterior longitudinal member to define an overlap area, and wherein the first exterior side includes a first side welding hole located in the overlap area and the second exterior side includes a second side welding hole located in the overlap area;
a first side hole weld extending around at least a portion of a perimeter of the first side welding hole and engaging the first side; and
a second side hole weld extending around at least a portion of a perimeter of the second side welding hole and engaging the second side.

12. The assembly of claim 11 wherein the lower exterior side includes a lower welding hole, and a lower weld extends around at least a portion of a perimeter of the lower welding hole and engages the lower side.

13. The assembly of claim 12 wherein the upper exterior side includes an upper welding hole, and an upper weld extends around at least a portion of a perimeter of the upper welding hole and engages the upper side.

14. The assembly of claim 11 wherein the exterior longitudinal member includes an end, and a perimeter weld extends around at least a portion of the end and engages the interior longitudinal member.

15. The assembly of claim 11 wherein the first side welding hole and the second side welding hole are the same size and shape.

16. A method of forming a longitudinal member joint between a boxed-section interior longitudinal member and a boxed-section exterior longitudinal member, the method comprising the steps of:
forming a first side welding hole in a first side of the exterior longitudinal member, with the first side being parallel to a plane defined by a longitudinal axis oriented along a length of the interior longitudinal member and a primary loading direction axis that extends parallel to a primary loading direction and perpendicular to the longitudinal axis;
forming a second side welding hole in a second side of the exterior longitudinal member, with the second side being parallel to and spaced from the first side;
telescopically inserting the interior longitudinal member into the exterior longitudinal member creating an overlap area where a first internal side of the interior longitudinal member is adjacent to the first side welding hole and a second internal side of the interior longitudinal member is adjacent to the second side welding hole;
welding at least a portion of a perimeter of the first side welding hole to the first internal side; and
welding at least a portion of a perimeter of the second side welding hole to the second internal side.

17. The method of claim 16 further comprising the steps of:
forming a lower hole in a lower side of the exterior longitudinal member, where the lower side extends between the first and second sides; and
welding at least a portion of a perimeter of the lower hole to a lower internal side of the interior longitudinal member.

18. The method of claim 17 further comprising the steps of:
forming an upper hole in an upper side of the exterior longitudinal member, where the upper side extends between the first and second sides and is spaced from the lower side; and
welding at least a portion of a perimeter of the upper hole to an upper internal side of the interior longitudinal member.

19. The method of claim 16 further comprising the step of welding at least a portion of an end of the exterior longitudinal member to at least one of the first internal side and the second internal side.

20. The method of claim 16 wherein the first side welding hole and the second side welding hole are formed the same size and shape.
